(19) United States
(12) Patent Application Publication
(10) Pub. No.: US 2005/0180899 A1
(43) Pub. Date: Aug. 18, 2005

(54) Underfloor catalyst assembly for an automobile

(76) Inventor: Sang Beom Kim, Suwon-si (KR)

Correspondence Address: MORGAN, LEWIS & BOCKIUS LLP (SF), 2 PALO ALTO SQUARE, PALO ALTO, CA, 94306, US

(21) Appl. No.: 11/016,212

(22) Filed: Dec. 17, 2004

(30) Foreign Application Priority Data
Dec. 31, 2003 (KR) 2003-0101441

(51) Int. Cl. B01D 53/34; F01N 3/10

(52) U.S. Cl. 422/180; 422/179; 422/177

(57) ABSTRACT

An underfloor catalyst assembly for an automobile includes a flange structure that is a compact structure so that a tool for connecting a front flange and an exhaust system pipe of an underfloor catalyst assembly can be inserted and the connection can be performed at a side of the catalyst assembly. Furthermore, the catalyst assembly is positioned near the engine for thereby enhancing performance of a LOT (Light Off Temperature). Flow distribution is made uniform in a cross section of a catalyst carrier by adapting a circular cross section structure. In addition, a desired performance is obtained by enhancing purification performance of the catalyst assembly, while reducing volume and fabrication cost as compared to the conventional catalyst assembly.

### CROSS-REFERENCE TO RELATED APPLICATION(S)

This application claims priority of Korean Application No. 10-2003-0101441, filed on Dec. 31, 2003, the disclosure of which is incorporated fully herein by reference.

### TECHNICAL FIELD OF THE INVENTION

Generally, the present invention relates to an underfloor catalyst assembly for an automobile. More particularly the underfloor catalyst assembly includes a compact-structured flange that allows relatively easy access from a side of the catalyst assembly and positioning of the catalyst assembly close to an engine so that the catalyst rapidly reaches Light-Off Temperature (LOT). Furthermore, the catalyst assembly includes a catalyst carrier having a circular cross-section for uniform flow distribution of exhaust gasses.

### BACKGROUND OF THE INVENTION

Typically, an underfloor catalyst assembly of an automobile is exposed under extreme circumstances, such as noise, thermal expansion due to high temperature, corrosion by exhaust gasses, etc. Taking these conditions into consideration, various kinds of catalyst assemblies have been developed. For example, in Japanese patent laid-open No. 2002-97942, there is provided a cylindrical catalyst converter for preventing a shroud and an outer container from being damaged by thermal expansion.

According to Japanese patent laid-open No. 11-270335, there is provided a catalyst converter capable of reducing noise and enhancing insulation. Furthermore, this design absorbs the difference of thermal expansion between diffusers and the catalyst converter by eliminating a procedure of integrally welding the front and rear diffusers to the catalyst converter.

Japanese patent laid-open No. Hei 11-50839 discloses a cover for a catalyst converter having a mounting flange, which enables reduction in noise and weight while ensuring sufficient mechanical strength. Furthermore, according to Japanese patent laid-open No. Hei 7-180544, there is provided a catalyst converter capable of achieving a desired air-tight casing without addition of component by providing a protector with the casing.

Accordingly, a conventional underfloor catalyst assembly includes two catalyst carriers of a honeycomb structure for purification of exhaust gas by means of a catalyst coated thereon. Two mats that are capable of supporting the catalyst carriers, four sealing members capable of preventing corrosion of the mats configured in such a manner that the mats are not exposed to the exhaust gas. Furthermore, a shell encompasses the catalyst carriers and the mats while a cover prevents thermal and impact damage to the assembly. A rear flange part and a front flange part connect to the exhaust pipe in a substantially longitudinal direction of the vehicle and a pipe.

Because purification performance of an underfloor catalyst assembly is generally optimized at over 350° C., it is preferable to dispose the catalyst assembly close to the engine in order to reduce a preheating time. It is further preferable to reduce thermal capacity of the catalyst assembly so as to minimize any loss of heat.

In the conventional underfloor catalyst assembly, because fabrication of the catalyst assembly is generally performed at a side of an exhaust pipe, it is necessary to ensure a working space of approximately 200 mm in length in order to prevent an interference between a working tool and other elements of the vehicle, such as a power-steering gear box, a stabilizer bar, and a drive shaft. This means the catalyst assembly should be inevitably located away from an engine by at least 200 mm. Considering the fact that two catalyst carriers are often disposed within a certain interval, there is a possibility to compact the structure of the catalyst assembly. Furthermore, the conventional catalyst assembly is disadvantageous in that the outlay increases due to the additional sealing member in comparison with a catalyst assembly having one catalyst carrier.

Since flow distribution of exhaust gasses is not uniform in a cross section of a conventional catalyst carrier having an elliptical shape, a desired preheating effect of the catalyst assembly and a desired purificability of the exhaust gasses is not achieved. In order to compensate the preheating effect and purificability, an increase of volume is additionally required. However, an increase in the overall volume of the catalyst assembly leads to a disadvantage in aspects of economy. Furthermore, the typical clinching mechanism of coupling structure for the shell and the cover is not secure and the components often loosen during use.

### SUMMARY OF THE INVENTION

Embodiments of the present invention provide an underfloor catalyst assembly for an automobile capable of overcoming the disadvantages in the conventional art. A primary object of the present invention is to provide an underfloor catalyst assembly for an automobile having a compact-structured flange which allows easy access by a working tool from a side of the catalyst assembly when the flange of the catalyst assembly is coupled to an exhaust pipe. The catalyst assembly is also positioned close to an engine so that a catalyst coated thereon rapidly reaches a LOT.

Another objection of the present invention is to provide an underfloor catalyst assembly having a catalyst carrier with a circular cross-section for uniform flow distribution of an exhaust gas therein. Thereby, the purificability of the catalyst assembly is improved while the overall volume is reduced and production cost is reduced.

According to an embodiment of the underfloor catalyst assembly a catalyst carrier of a honeycomb structure capable of purifying an exhaust gas by means of a catalyst coated thereon includes a mat for supporting the catalyst carrier and a sealing member for preventing corrosion of the mat. A shell encompasses the catalyst carrier and the mat therein and a cover prevents thermal and impact damages from being transferred to the catalyst assembly. A front pipe and a front flange part are connected to an exhaust pipe in a substantially longitudinal direction of the vehicle, wherein the front flange slants toward the catalyst carrier such that easy access for a working tool from a lower side is generated when the catalyst assembly is attached to an exhaust pipe. Furthermore, the front pipe is integrally formed with the front flange.

The catalyst carrier is formed in a single structure so that the numbers of relevant components, such as the mat for supporting the catalyst carrier and the sealing member for preventing corrosion of the mat can be reduced. The catalyst carrier preferably has a substantially circular cross section for achieving a uniform flow distribution in its cross section. The corner portions of both sides of the shell and the cover are surrounded by a fixing part of the cover in a clinching structure.

### BRIEF DESCRIPTION OF THE DRAWINGS

The aforementioned aspects and other features of the present invention will be explained in the following description, taken in conjunction with the accompanying drawings, wherein:

FIG. 1 is a perspective view illustrating an underfloor catalyst assembly for an automobile according to an embodiment of the present invention;

FIG. 2 is a front view illustrating an underfloor catalyst assembly for an automobile according to an embodiment of the present invention;

FIG. 3 is a lateral view illustrating an underfloor catalyst assembly for an automobile according to an embodiment of the present invention;

FIG. 4 is a graph of an infirmity index of an exhaust flow distribution of an underfloor catalyst assembly for an automobile according to an embodiment of the present invention;

FIG. 5 is a view illustrating a thermal strain degree of an underfloor catalyst assembly for an automobile according to an embodiment of the present invention;

FIG. 6 is a view illustrating a back pressure with respect to a revolution of an engine of an underfloor catalyst assembly for an automobile according to an embodiment the present invention;

FIG. 7 is a view illustrating a connection work of a front flange and a pipe of an exhaust system of an underfloor catalyst assembly for an automobile according to an embodiment of the present invention;

FIG. 8 illustrates a coupling structure of a shell and a cover of an underfloor catalyst assembly for an automobile according to an embodiment of the present invention; and

FIG. 9 illustrates yet another connection of a front flange and a pipe of an exhaust system of an underfloor catalyst assembly for an automobile according to another embodiment of the present invention.

### DETAILED DESCRIPTION OF PREFERRED EMBODIMENTS

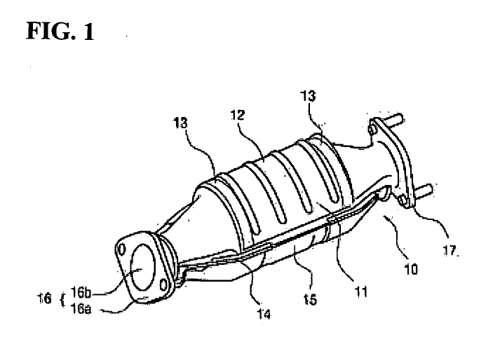

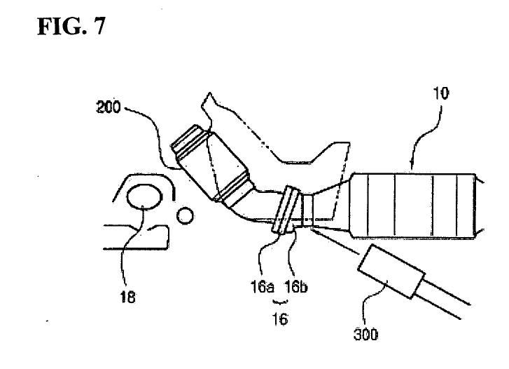

According to FIG. 1, the underfloor catalyst assembly 10 includes a compact-structured flange 16 which allows a working tool easy access to the catalyst assembly 10 from the side of the catalyst assembly 10 when the flange 16 of the catalyst assembly 10 is coupled to an exhaust pipe 200 (FIG. 7) of a vehicle. Such a flange 16 further enables the catalyst assembly 10 to be positioned close to an engine so that a catalyst compound within the catalyst assembly 10 rapidly reaches to Light-Off Temperature (LOT). In addition, the catalyst assembly 10 includes a catalyst carrier 11 having a substantially circular cross-section for uniform flow distribution of exhaust gas therethrough.

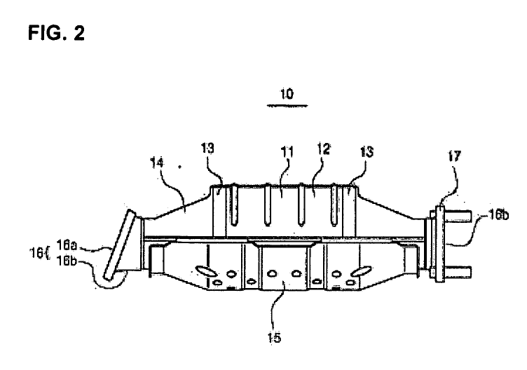

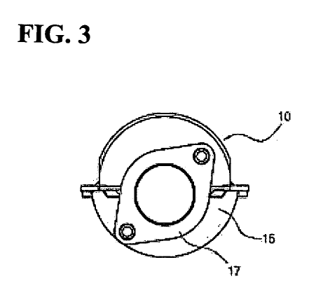

As shown in FIGS. 1-3, the underfloor catalyst assembly 10 includes a catalyst carrier 11 having a honeycomb structure, which purifies exhaust gasses by means of a catalyst coated thereon. A front flange part 16 is connected to an exhaust pipe 200 in a substantially longitudinal direction of the vehicle. A mat 12 is provided to firmly support the catalyst carrier 11. The mat 12 is furnished with a sealing member 13 capable of preventing corrosion thereof by preventing the mat 12 from being exposed to the exhaust gasses. A cover 15 is further provided to protect the catalyst assembly from thermal and impact damages. Encompassing the catalyst carrier 11 and the mat 12 is a shell 14. A front flange part 16 connected to an exhaust pipe 200 and a rear front flange 17 is formed at both ends of the catalyst assembly 10.

According to an embodiment the catalyst carrier 11 is implemented in an intensive structure that two constructions are integrated into one construction. Therefore, the mat 12, supporting the catalyst carrier 11, is also formed in a single structure. Two sealing members 13 are installed at both ends of the mat 12 while preventing permeation of an exhaust gas to the mat 12. In the catalyst carrier 11, a circular cross section is adopted in order to achieve a uniform flow distribution in the cross section of the catalyst carrier 11. Therefore, it is possible to reduce the volume of the catalyst carrier 12 as compared to the conventional catalyst carrier having an elliptical cross section. Furthermore, the structure of the catalyst carrier 11 is compacted, so that the numbers of mats 12 and sealing members 13 are decreased, thereby leading to a reduction in the overall size of the underfloor catalyst assembly 10. Also, the sizes of the shell 14 and cover 15 can be accordingly reduced.

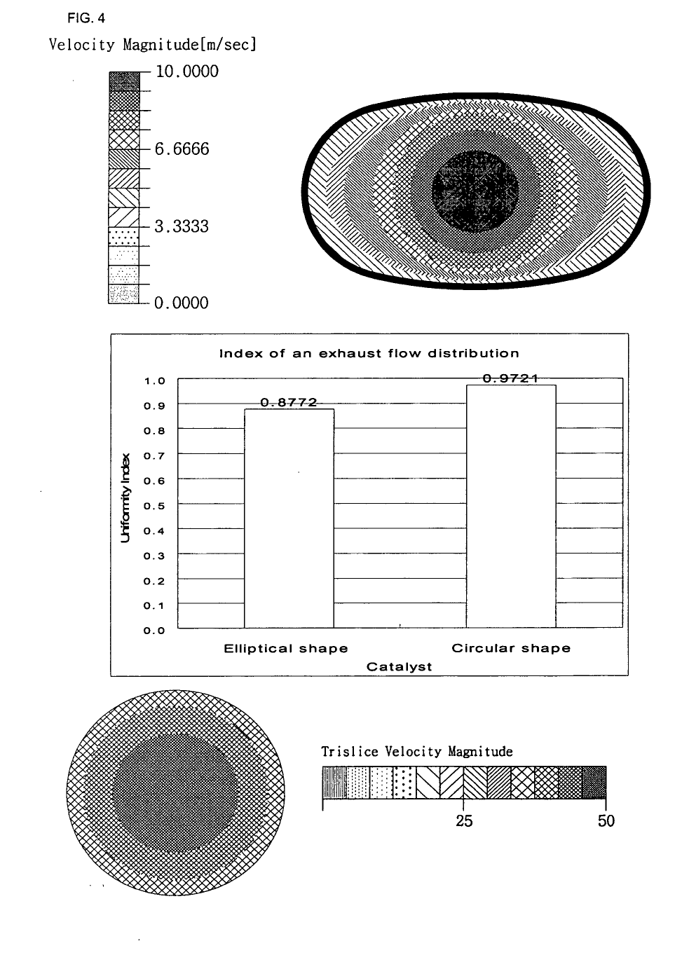

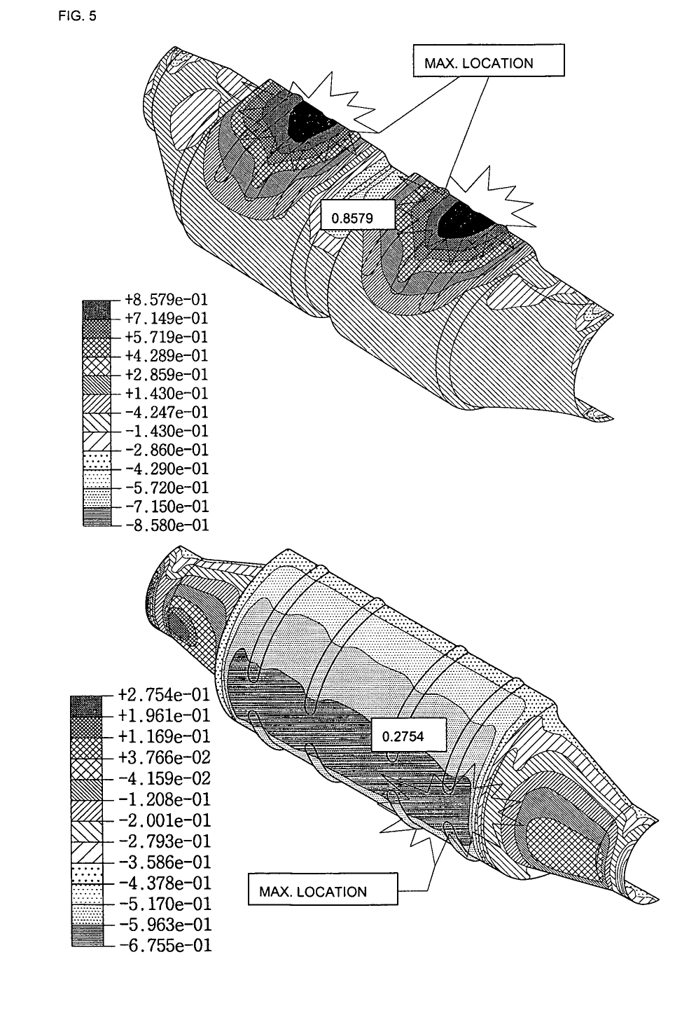

According to FIG. 4, an embodiment of the catalyst assembly 10 employs a substantially circular cross section such that the flow distribution of the exhaust gasses reaches a uniformity index of about 0.972 as compared with the conventional index of about 0.877. Furthermore, the total volume is changed from about 1.8 L to about 1.52 L in the present invention with a circular cross section structure. As shown in FIG. 5, in view of the thermal strain degree based on the change to the circular cross section structure, it is possible to achieve about 60% improvement (0.86->0.27: maximum strain degree), such that durability is excessively increased.

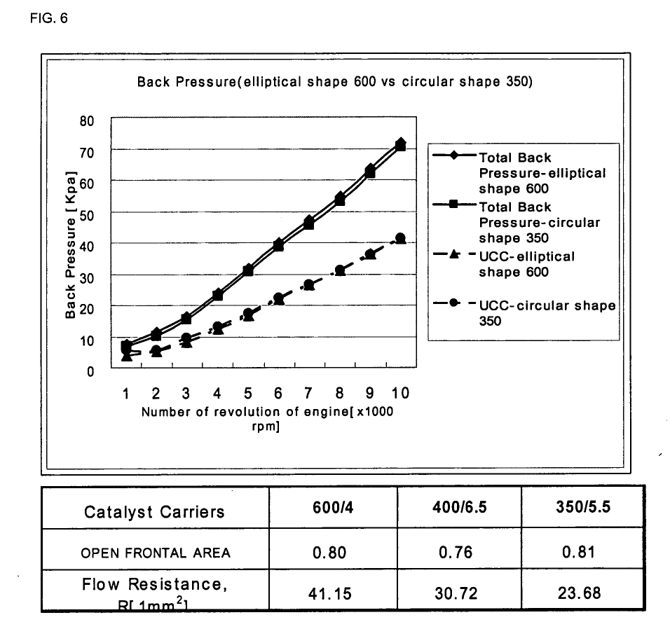

As shown in FIG. 6, an increase in back pressure is prevented by adopting the catalyst carrier 11 formed of low celuthin cell having a lower flow resistance. The performance of the underfloor catalyst assembly 10 depends on the speed of activation of the catalyst compound. Therefore, it is advantageous that the temperature reaches the activation temperature (LOT) as soon as possible. Accordingly, as shown in FIG. 7, the flange structure and a fixing unit are configured in a compact size in such a manner that a fabricating work is performed at the side of the underfloor catalyst assembly 10 for connecting the front flange unit 16 to the exhaust pipe 200. Therefore, the underfloor catalyst assembly 10 is positioned adjacent the engine of the vehicle without interfering with other components of the vehicle, such as, a power steering gear box, a stabilizer bar, drive shaft, or the like. According to an embodiment, the front flange part 16 is preferably formed by integrally connecting a cast type flange 16a to the front pipe 16b. The front flange part 16 is also preferably connected to the shell 14.

The front flange part 16 slants toward the catalyst assembly 11 by approximately 20 degrees such that a working tool 300 (FIG. 7) can be easy inserted or approached from a lower side when the catalyst assembly is attached to the exhaust pipe 200 of the vehicle. Namely, the lower part of the pipe 16b of the front flange part 16 is relatively longer than the upper part of the same so as to facilitate access by the working tool 300. The front end of the pipe 16b has an inclined structure. Moreover, the pipe 16b and the flange 16a can be integrally formed.

The front flange 16a is further furnished with a fixing means such as bolts and nuts for fastening the same to the vehicle, the fastening procedure being performed at the side of the catalyst assembly 10. Since the underfloor catalyst assembly 10 is closely positioned to an engine, the LOT performance of the catalyst assembly 10 is improved. Therefore, the catalyst assembly may be substituted by an inexpensive device containing a very small amount of precious metal. According to a preferred embodiment, a Pt catalyst may be substituted by a Pd catalyst, while maintaining the same purificability as that of the conventional art. Consequently, fabrication cost can be reduced.

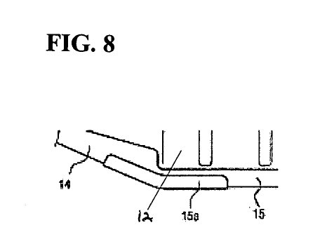

As shown in FIG. 8, the clinching method for coupling the cover 15 to the shell 14 is directed to a method in which both sides of the shell 14 are covered by the cover 15. A stable fixing is achieved by changing the position and shape of the clinching portion. Therefore, additional welding work is eliminated in the present invention. Namely, in the conventional art, the cover 150 is clinched only to a straight 3-section (front/center/rear straight sections of shell) at both sides of the shell 14, so that the clinched fixing part 151 may be damaged and widened by an external impact and is escaped from the shell 140 and thereby generates much noise. Therefore, in the conventional art, a certain measurement is urgently needed. However, according to an embodiment of the present invention, at least one corner portion (14a) of both sides of the shell 14 is clinched by the fixing part 15a of the cover 15 for thereby achieving a very stable structure so that additional coupling work is not needed.

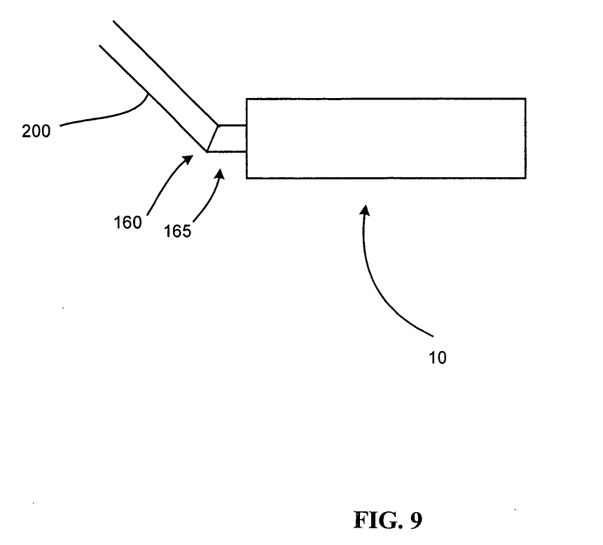

FIG. 9 shows another coupling of the exhaust pipe 200 with the underfloor catalyst assembly 10. According to this embodiment, a rearward portion 160 of the exhaust pipe 200 terminates in an angle relative to an axial direction of the exhaust pipe 200. Likewise, a forward section 165 of the underfloor catalyst assembly 10 terminates in an angle relative to an axial direction of the underfloor catalyst assembly 10. When assembled, the exhaust pipe 200 and the underfloor catalyst assembly 10 meet at their respective angled portions and the pipe and catalyst assembly are coupled together. In use, by coupling the exhaust pipe 200 and underfloor catalyst assembly 10 together at the angle, space is saved such that the underfloor catalyst assembly 10 can be moved further forward, with respect to the vehicle, and the underfloor catalyst assembly 10 can be heated quickly for more efficient operation. It will be appreciated by one of ordinary skill in the art that the rearward end 160 of the exhaust pipe 200 and the forward end 165 of the underfloor catalyst assembly 10 can include a coupling or other suitable mechanism for mutual attachment.

According to another embodiment, the underfloor catalyst assembly includes a compact-structured flange which allows a working tool easy access site from the side of the catalyst assembly when the flange of the catalyst assembly is coupled to the exhaust pipe. The compact-structured flange further enables the catalyst assembly to be mounted close up to the engine so that the catalyst rapidly reaches a Light-Off Temperature. In addition, the catalyst assembly comprises a catalyst carrier with a circular cross-section for uniform flow distribution of exhaust gasses therein, whereby the overall volume of the catalyst assembly can be reduced from the conventional catalyst assemblies without lowering of purificability of exhaust gasses.

As compared to the conventional catalyst assemblies, the present invention has the following improvements and advantages. Even though the volume of the catalyst carrier is changed from about 1.8 L to about 1.52 L, the LOT performance and purificability of the catalyst assembly is improved and the back pressure is maintained at the substantially same level. Furthermore, by reducing the number of mats needing fabrication, the procedure for covering the catalyst carrier with mats can be simplified. A compacted structure of the front flange enables bypassing the welding process between the front flange and the front pipe. Furthermore, additional welding processes are eliminated by improving the structure of the cover clinching structure. By adopting a catalyst carrier of single structure, many of the relevant components, such as mats and sealing members, can be significantly reduced, thereby leading to reduction in the outlay.

1. An underfloor catalyst assembly, comprising:
a catalyst carrier of a honeycomb structure capable of purifying an exhaust gas by means of a catalyst coated thereon;
a mat for supporting the catalyst carrier;
a sealing member for preventing corrosion of the mat;
a shell encompassing the catalyst carrier and the mat therein;
a cover for protecting the catalyst assembly form thermal damages and impacts from being transferred thereto;
a front flange part being connected to an exhaust pipe of a vehicle in a substantially longitudinal direction of the vehicle; and
a front pipe connecting the front flange to the shell, wherein the front flange slants toward the catalyst carrier for easy approach of a working tool from a lower side when the catalyst assembly is attached to an exhaust pipe of a vehicle.

2. The underfloor catalyst assembly according to claim 1, wherein the catalyst carrier is formed in a single structure so that the numbers of the mat supporting the catalyst carrier and the sealing member preventing corrosion of the mat are reduced.

3. The underfloor catalyst assembly according to claim 2, wherein the catalyst carrier has a circular cross section for achieving a uniform flow distribution in cross section thereof.

4. The underfloor catalyst assembly according to claim 1, wherein the front flange part further comprises a fixing means for coupling to the exhaust pipe.

5. The underfloor catalyst assembly according to claim 1, wherein at least a corner portion of both sides of the shell and the cover is surrounded by a fixing part of the cover in a clinching structure.

6. The underfloor catalyst assembly according to claim 1, wherein the front flange is disposed adjacent to a power steering gear box at a front side of an automobile.

7. The underfloor catalyst assembly according to claim 1, wherein the front flange is disposed adjacent to a stabilizer bar at a front side of an automobile.

8. The underfloor catalyst assembly according to claim 1, wherein the front flange is disposed adjacent to a drive shaft at a front side of an automobile.

9. The underfloor catalyst assembly according to claim 1, wherein said front pipe is integrally formed with the front flange.

10. The underfloor catalyst assembly according to claim 2, wherein said front pipe is integrally formed with the front flange.

11. The underfloor catalyst assembly according to claim 3, wherein said front pipe is integrally formed with the front flange.

12. An underfloor catalyst assembly, comprising:
a catalyst carrier having a honeycomb structure and being capable of purifying exhaust gasses passing therethrough;
a mat for supporting the catalyst carrier;
a sealing member for preventing corrosion of the mat;
a shell encasing the catalyst carrier and the mat;
a cover for protecting the catalyst assembly form thermal and impact damage;
a front flange part being connected to an exhaust pipe of a vehicle; and
a front pipe connecting the front flange to the shell, wherein the front flange slants toward the catalyst carrier such that a working tool can be easily inserted from a lower side when the catalyst assembly is attached to the exhaust pipe.

13. An underfloor catalyst assembly in combination with an exhaust pipe, comprising:
a catalyst assembly for purifying exhaust gasses;
an exhaust pipe extending from an engine toward the catalyst assembly;
a front flange coupled toward a front of the catalyst assembly;
a rear flange coupled toward a rear of the exhaust pipe, wherein the front flange and rear flange are slanted, such that, upon coupling said front flange with said rear flange, said exhaust pipe and said catalyst assembly form an angle therebetween.
